(19) United States
(12) Patent Application Publication
(10) Pub. No.: US 2017/0276231 A1
(43) Pub. Date: Sep. 28, 2017

(54) DUST COVER, STEERING DEVICE, AND DAMPER

(71) Applicants: Showa Corporation, Gyoda-shi (JP); Fukoku Bussan Co., Ltd., Tokyo (JP)

(72) Inventors: Shinsuke SEKIKAWA, Haga-gun (JP); Koetsu ABE, Haga-gun (JP); Shinichi SUTOU, Tokyo (JP)

(73) Assignees: Showa Corporation, Gyoda-shi (JP); Fukoku Bussan Co., Ltd., Tokyo (JP)

(21) Appl. No.: 15/470,424

(22) Filed: Mar. 27, 2017

(30) Foreign Application Priority Data
Mar. 28, 2016 (JP) 2016-064668

(51) Int. Cl. F16H 57/031; F16F 9/38; F16H 57/032; B62D 3/12; F16H 19/04

(52) U.S. Cl. CPC F16H 57/031; B62D 3/126; F16H 19/04; F16H 57/032; F16F 9/38; F16H 2057/02082

(57) ABSTRACT

A dust cover to cover an opening of a housing through which at least one of a shaft and a pipe extends includes a hole-edge portion and a main body. The at least one of the shaft and the pipe is extendable through the through hole. The hole-edge portion defines an edge of a through hole through which the at least one of the shaft and the pipe is extendable. The main body is configured to cover the opening. The main body has a hardness different from a hardness of the hole-edge portion.

### CROSS-REFERENCE TO RELATED APPLICATION(S)

The present application claims priority under 35 U.S.C. §119 to Japanese Patent Application No. 2016-064668, filed Mar. 28, 2016. The contents of this application are incorporated herein by reference in their entirety.

### BACKGROUND

Technical Field

The present invention relates to a dust cover, a steering device, and a damper.

Related Art

A steering gearbox, which is a component of a steering device for a vehicle, includes a dust cover to cover an opening from which an input shaft protrudes so as to prevent fluid or dust, for example, from entering inside from the opening. JP-2013-067280-A, JP-2012-066670-A and JP-2013-043555-A disclose this kind of dust covers attached to an input shaft.

The steering gearbox also includes dust covers (dust boots) to cover openings from which a rack shaft or tie rods protrude. A damper, which is a component of a suspension for a vehicle, includes a dust cover to cover an opening from which a piston rod protrudes.

### SUMMARY

According to one aspect of the present invention, a dust cover to cover an opening of a housing through which at least one of a shaft and a pipe extends includes a hole-edge portion and a main body. The hole-edge portion defines an edge of a through hole through which the at least one of the shaft and the pipe is extendable. The main body has a hardness different from a hardness of the hole-edge portion.

According to another aspect of the present invention, a steering device includes a housing, at least one of a shaft and a pipe, and a dust cover. The at least one of the shaft and the pipe extends through an opening disposed in the housing. The dust cover is configured to cover the opening and includes a hole-edge portion and a main body. The hole-edge portion defines an edge of a through hole through which the at least one of the shaft and the pipe is extendable. The main body is configured to cover the opening. The main body has a hardness different from a hardness of the hole-edge portion.

According to the other aspect of the present invention, a damper includes a case, a piston rod, and a dust cover. The piston rod extends through an opening formed in the case. The dust cover is configured to cover the opening and includes a hole-edge portion and a main body. The hole-edge portion defines an edge of a through hole through which the piston rod is extendable. The main body is configured to cover the opening. The main body has a hardness different from a hardness of the hole-edge portion.

### BRIEF DESCRIPTION OF THE DRAWINGS

A more complete appreciation of the invention and many of the attendant advantages thereof will be readily obtained as the same becomes better understood by reference to the following detailed description when considered in connection with the accompanying drawings,

wherein:

FIG. 1 is a diagram schematically illustrating an exemplary configuration of a steering device according to embodiment 1;

FIG. 2 is a perspective view of a wheel-turning portion of the steering device according to embodiment 1;

FIG. 3 is a perspective view of a dust cover according to embodiment 1;

FIG. 4 is a cross-sectional view of the dust cover, taken along the line AA in FIG. 3;

FIG. 5 is a cross-sectional view of a dust cover according to embodiment 2;

FIGS. 6A and 6B are perspective views of dust covers and positioning members according to embodiment 3;

FIG. 7 is a perspective view of a dust boot according to embodiment 4;

FIGS. 8A and 8B are cross-sectional views of the dust boots according to embodiment 4 and components surrounding the dust boots;

FIGS. 9A and 9B are perspective views of dust covers according to embodiment 5; and

FIG. 10 is a cross-sectional view of a damper according to embodiment 5.

### DESCRIPTION OF THE EMBODIMENTS

The embodiments will now be described with reference to the accompanying drawings, wherein like reference numerals designate corresponding or identical elements throughout the various drawings.

### Embodiment 1

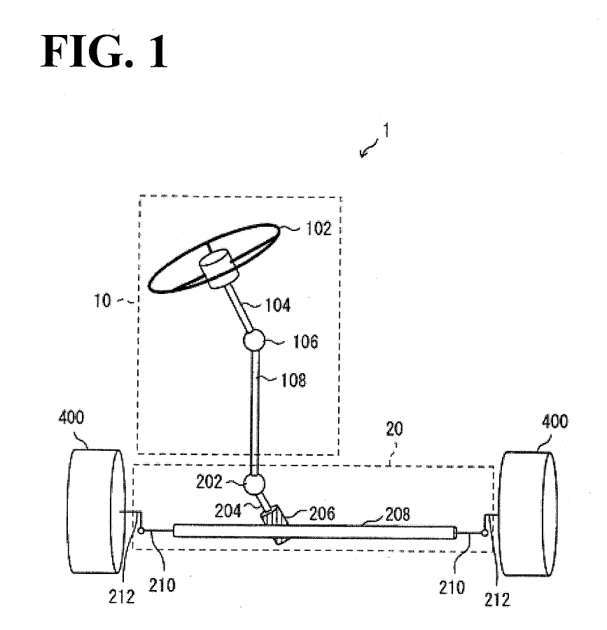

A steering device 1 according to one embodiment will now be described with reference to FIG. 1.

FIG. 1 is a diagram schematically illustrating an exemplary configuration of the steering device 1 for a vehicle. As illustrated in FIG. 1, the steering device 1 includes a steering portion 10 and a wheel-turning portion 20. The steering portion 10 accepts steering operation by a driver. In accordance with the steering operation accepted by the steering portion 10, the wheel-turning portion 20 turns wheels 400.

As an example of the steering device 1, as illustrated in FIG. 1, the steering portion 10 and the wheel-turning portion 20 are mechanically coupled to each other constantly. This, however, should not limit this embodiment. The steering device 1 may be a Steer-By-Wire (SBW) steering device, for example.

### Steering Portion 10

As illustrated in FIG. 1, the steering portion 10 includes a steering member 102, a steering shaft 104, a first universal joint 106, and an intermediate shaft 108. The steering member 102, the steering shaft 104, and the intermediate shaft 108 are coupled to each other in a torque transmittable manner. Here, “coupled in a torque transmittable manner” refers to coupled in such a manner that rotation of one member causes rotation of another member. In a non-limiting example, this at least includes when one member and another member are integral to each other, when one member is directly or indirectly secured to another member, and when one member and another member are coupled through, for example, a joint member so as to operate in conjunction with each other.

In this embodiment, an upper end of the steering shaft 104 is secured to the steering member 102 and integrally rotates with the steering member 102. A lower end of the steering shaft 104 and an upper end of the intermediate shaft 108 are coupled through the first universal joint 106 in such a manner that the steering shaft 104 and the intermediate shaft 108 operate in conjunction with each other.

In the description, “upper end” refers to an end at an upstream side in a transmission path of steering force in accordance with steering operation by the driver (namely, an end on an input side), and “lower end” refers to an end at a downstream side in the transmission path of steering force (namely, an end on an output side) (the same applies below).

As an example of the steering member 102, as illustrated in FIG. 1, a ring-shaped steering wheel is given. This, however, should not limit this embodiment. The steering member 102 may have a different shape and mechanism insofar as it is possible to accept steering operation by the driver.

### Wheel-Turning Portion 20

As illustrated in FIG. 1, the wheel-turning portion 20 includes a second universal joint (universal joint) 202, a pinion shaft (input shaft, shaft) 204, a pinion gear 206, a rack bar (wheel-turning shaft) 208, tie rods 210, and knuckle arms 212. The intermediate shaft 108, the pinion shaft 204, and the pinion gear 206 are coupled to each other in a torque transmittable manner. In this embodiment, the pinion shaft 204 is a shaft. As the pinion shaft 204, however, a hollow pipe may be used.

In this embodiment, the pinion gear 206 is secured to a lower end of the pinion shaft 204 and integrally rotates with the pinion shaft 204. A lower end of the intermediate shaft 108 and an upper end of the pinion shaft 204 are coupled through the second universal joint 202 in such a manner that the intermediate shaft 108 and the pinion shaft 204 operate in conjunction with each other.

The rack bar 208 is a configuration for turning the wheels 400 in accordance with rotation of the pinion gear 206. Rack teeth to mesh with the pinion gear 206 are formed on the rack bar 208.

Although not illustrated in FIG. 1, the wheel-turning portion 20 includes a steering gearbox housing to accommodate a lower-end side of the pinion shaft 204, the pinion gear 206, and the rack bar 208.

In the steering device 1 of the above-described configuration, when the driver performs steering operation through the steering member 102, the pinion gear 206 rotates, and the rack bar 208 is displaced in an axial direction of the rack bar 208. Thus, through the tie rods 210 disposed on both ends of the rack bar 208 and the knuckle arms 212 coupled to the tie rods 210, the wheels 400 are turned.

In the example illustrated in FIG. 1, the configuration is adopted in which transmission of steering force between the pinion shaft 204 and the rack bar 208 is performed by the pinion gear 206 and the rack teeth. This, however, should not limit this embodiment. Other configurations may be adopted insofar as steering force can be transmitted between the pinion shaft 204 and the rack bar 208.

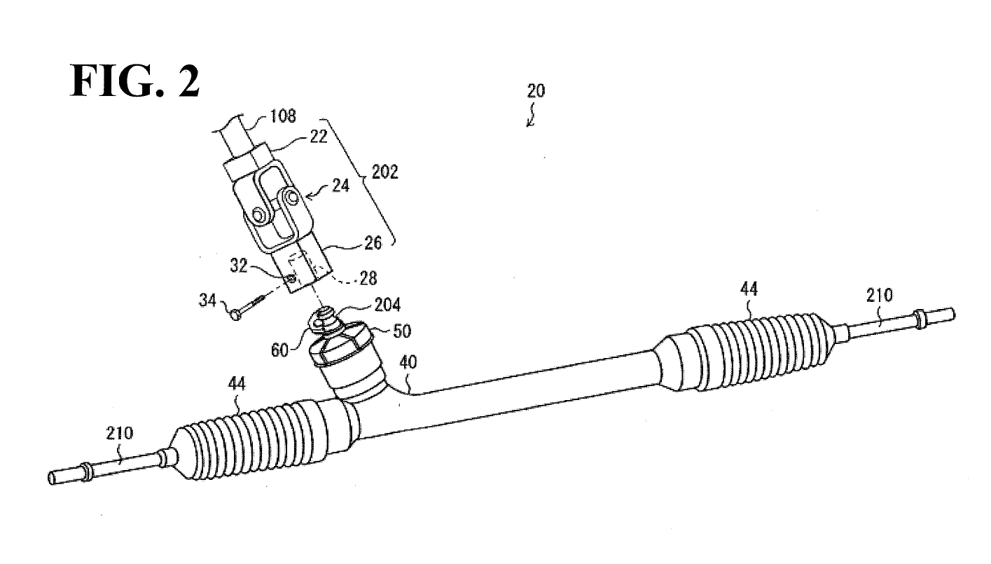

FIG. 2 is a perspective view of the wheel-turning portion 20 according to this embodiment, illustrating an exemplary configuration of the wheel-turning portion 20. The lower-end side of the pinion shaft 204, the pinion gear 206, and the rack bar 208, which are illustrated in FIG. 1, are accommodated in the steering gearbox housing 40 (hereinafter simply referred to as housing 40) in FIG. 2. A portion of each of the tie rods 210 on the rack bar side is accommodated in a dust boot 44.

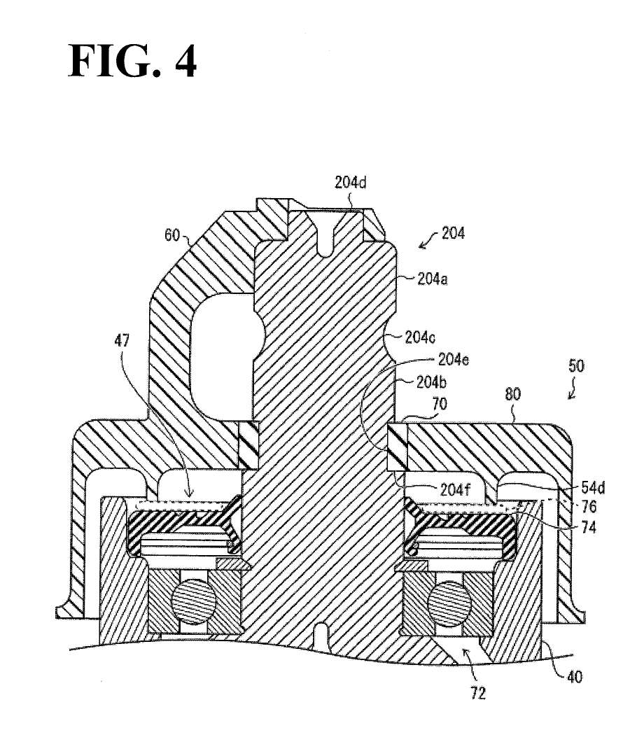

The housing 40 has an opening 47 (see FIG. 4) from which the pinion shaft 204 protrudes (through which the pinion shaft 204 extends). This opening 47 is covered with a dust cover 50 attached to the pinion shaft 204.

A positioning portion 60, which is integral to the dust cover 50, is attached to a protruding portion of the pinion shaft 204 that protrudes from the dust cover 50. A serration (not illustrated) is formed on the protruding portion of the pinion shaft 204 and extends in an axial direction of the pinion shaft 204. The positioning portion 60 is secured to the pinion shaft 204 in such a manner that the positioning portion 60 meshes with the serration. It is noted that the serration may include teeth or grooves.

As illustrated in FIG. 2, the second universal joint 202 includes a first joint yoke 22, a second joint yoke 26, and a joint portion 24. The first joint yoke 22 is secured to the lower end of the intermediate shaft 108 and integrally rotates with the intermediate shaft 108. The second joint yoke 26 is attached to the protruding portion of the pinion shaft 204. The joint portion 24 couples the first joint yoke 22 and the second joint yoke 26 to each other.

The second joint yoke 26 has a coupling hole 28, a slit (not illustrated), and a through hole 32. The slit extends in a direction in which the coupling hole 28 extends. The through hole 32 is formed across the slit. A serration is formed on an inner surface of the coupling hole 28 and extends in the direction in which the coupling hole 28 extends. The serration meshes with the serration of the protruding portion of the pinion shaft 204.

When the second joint yoke 26 is coupled to the pinion shaft 204, the second joint yoke 26 is positioned in a circumferential direction to fit the positioning portion 60 in the slit, and in this state, the protruding portion of the pinion shaft 204 is inserted in the coupling hole 28. With the protruding portion of the pinion shaft 204 being inserted in the coupling hole 28, a bolt 34 is inserted and tightened in the through hole 32 of the second joint yoke 26. Thus, the second joint yoke 26 is secured to the pinion shaft 204.

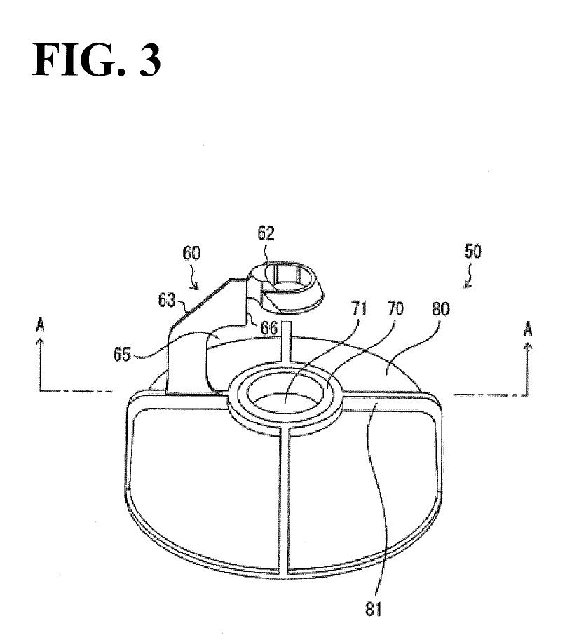

Next, by referring to FIGS. 3 and 4, the dust cover 50 according to this embodiment will be described in detail.

FIG. 3 is a perspective view of the dust cover 50 according to this embodiment.

### Dust Cover 50

The dust cover 50 covers the opening 47 from which the pinion shaft 204 (see FIG. 1) protrudes. The dust cover 50 includes a hole-edge portion 70 on an edge of a through hole 71 through which the pinion shaft 204 extends. The hole-edge portion 70 is formed to be fitted in a circumferential recess of the pinion shaft 204.

A main body 80 integral to the hole-edge portion 70 covers the opening 47. The main body 80 includes a plurality of ribs 81, which extend radially outward from the hole-edge portion 70. These ribs 81 improve strength of the dust cover 50. In this embodiment, the ribs 81 are not essential. A configuration with no ribs on the dust cover 50 is also possible. It is noted that the number of the ribs 81 should not be limited to the number according to this embodiment.

### Positioning Portion 60

In this embodiment, the positioning portion 60 to determine a position of the second universal joint 202 coupled to the pinion shaft 204 is disposed on an upper surface side of the main body 80.

The positioning portion 60 includes a crown portion 62, a protrusion 63, and a meshing portion 66. In a possible embodiment, the positioning portion 60 should be made of rigid material. More preferably, the positioning portion 60 should be made of the same material as the main body 80.

The crown portion 62 is a ring-shaped portion fitted on an end portion of the pinion shaft 204 (see FIG. 1) on the second universal joint 202 side from the outside.

The protrusion 63 is a plate-shaped portion to couple the main body 80 and the crown portion 62 to each other, and protrudes outward in the radial direction of the pinion shaft 204. When the second joint yoke 26 (see FIG. 2) is coupled to the pinion shaft 204, the protrusion 63 is fitted in the slit of the second joint yoke 26. The protrusion 63 has a recess 65. This recess 65 and a recess 204c (see FIG. 4) formed in the pinion shaft 204 form a through hole through which the bolt 34 (see FIG. 2) extends.

The meshing portion 66 meshes with the serration grooves formed in the pinion shaft 204 in the axial direction.

In this manner, the positioning portion 60 is highly accurately positioned and secured to both of the pinion shaft 204 and the second joint yoke 26. This makes the center of the pinion shaft 204 accord with the center of the second universal joint 202. In other words, the positioning portion 60 is attached to the pinion shaft 204 to determine a position of the second universal joint 202 coupled to the pinion shaft 204.

In this embodiment, the dust cover 50 including the positioning portion 60 is not an essential configuration. A positioning member that has a configuration similar to the positioning portion 60 and is separate from the dust cover 50 may be provided. An effect of providing the dust cover 50 with the positioning portion 60 will be described later. It is noted that even when the dust cover 50 and the positioning portion 60 are integral to each other, the positioning portion 60 may be made of material different from material of the hole-edge portion 70 and material of the main body 80.

FIG. 4 is a cross-sectional view of the dust cover 50, taken along the line AA in FIG. 3.

As illustrated in FIG. 4, the protruding portion of the pinion shaft 204 includes a first serration portion 204a (serration grooves) and a second serration portion 204b (serration grooves), each of which includes a plurality of serration grooves extending in the axial direction of the pinion shaft 204. The recess 204c is formed between the first serration portion 204a and the second serration portion 204b in the circumferential direction.

The pinion shaft 204 is rotatably supported on the housing 40 through a bearing 72. Also, as illustrated in FIG. 4, a dustproof seal 74 made of flexible material such as rubber is disposed on a side of the opening 47 of the housing 40, as viewed from the bearing 72. This dustproof seal 74 prevents water and dust, for example, from entering through the opening 47 of the housing 40. A ring-shaped dustproof rib 54d is disposed on a rear surface of the main body 80 and protrudes toward the housing 40. An area 76 between the dustproof rib 54d and the dustproof seal 74 is filled with grease. Thus, more suitably, dust is prevented from entering through the opening 47 of the housing 40. In the dust cover 50 according to this embodiment, however, the dustproof seal 74 and the dustproof rib 54d are not essential. A configuration without the dustproof seal 74 and the dustproof rib 54d is also possible.

As illustrated in FIG. 4, a circumferential recess 204e is formed in the pinion shaft 204 at a position where the dust cover 50 is attached. The through hole 71 of the dust cover 50 is fitted on the recess 204e from the outside. In other words, an outer diameter of the pinion shaft 204 at the position where the dust cover 50 is attached is smaller than an outer diameter of the first serration portion 204a and an outer diameter of the second serration portion 204b. This restricts a position of the dust cover 50 in the axial direction of the pinion shaft 204.

As illustrated in FIG. 4, the pinion shaft 204 includes the recess 204e and a stepped portion 204f, which is a portion of the recess 204e. An edge of a rear surface of the hole-edge portion 70 of the dust cover 50 is in contact with the stepped portion 204f. This suitably restricts a movement of the dust cover 50 away from an end portion 204d of the pinion shaft 204. That is, the hole-edge portion 70 of the dust cover 50 is fitted in the recess 204e in the circumferential direction of the pinion shaft 204.

Although not illustrated in FIG. 4, a torsion bar may be disposed in the pinion shaft 204, and a torque sensor may be disposed in a vicinity of the pinion shaft 204 to detect a steering torque so as to assist turning of the wheels in accordance with the detected steering torque. This, however, should not limit this embodiment.

In this embodiment, hardness of the main body 80 is set to be higher than hardness of the hole-edge portion 70. In other words, rigidity of the main body 80 is larger than rigidity of the hole-edge portion 70, and elasticity of the hole-edge portion 70 is larger than elasticity of the main body 80. More specifically, Shore hardness of the hole-edge portion 70 is set to be lower than Shore hardness of the main body 80. It is noted that the Shore hardness of the main body 80 and the Shore hardness of the hole-edge portion 70 may be set, for example, in a range in which Shore A provided by ASTM2240 or ISO7619 is equal to or higher than 10/15 (“/15” refers to confirmation after 15 seconds; the same applies below), and Shore D is equal to or less than 50/15. More preferably, for example, the Shore hardness of the main body 80 may be equal to or higher than Shore A 60/15, and the Shore hardness of the hole-edge portion 70 may be less than Shore A 60/15.

In this manner, in this embodiment, the dust cover 50 is made up of two portions, namely, the main body 80 and the hole-edge portion 70 integral to each other. The main body 80 is formed to be harder than the hole-edge portion 70. This improves a sealing property and also prevents the dust cover 50 from being turned over.

More specifically, when the dust cover 50 is attached to the pinion shaft 204, it is necessary to fit (insert) the hole-edge portion 70 in the recess 204e formed in the circumferential direction of the pinion shaft 204. In view of this, the hardness of the hole-edge portion 70 is decreased to provide elasticity (deformability and resilience) to improve an assembling property of the dust cover 50 with respect to the pinion shaft 204. This consequently improve the sealing property. Conversely, if the hole-edge portion 70 is hard, it is difficult to assemble the dust cover 50 with respect to the pinion shaft 204.

The dust cover 50 may be washed by high-pressure water. In view of this, the hardness of the main body 80 is increased to provide rigidity to prevent the dust cover 50 from being turned over by the high-pressure water.

In this manner, the main body 80 and the hole-edge portion 70 are different from each other in suitable hardness. Consequently, the dust cover 50 is made up of the two portions, and the main body 80 is formed to be harder than the hole-edge portion 70. This improves the sealing property and also prevents the dust cover 50 from being turned over.

A material of the hole-edge portion 70 (hereinafter also referred to as “hole-edge portion material”) and a material of the main body 80 (hereinafter also referred to as “main body material”) should not be particularly limited. For example, various resins, various rubbers, and appropriate combinations of resin and rubber may be used.

In a non-limiting embodiment, each of the hole-edge portion material and the main body material may have a resin component and a rubber component, and compounding ratios of resin components and rubber components of the hole-edge portion material and the main body material may be different from each other. Alternatively, one of the hole-edge portion material and the main body material may have a resin component and a rubber component, and the other of the hole-edge portion material and the main body material may have a resin component and no rubber component. This configuration facilitates adjustment of the hardness of the hole-edge portion 70 and the hardness of the main body 80.

As examples of the resin components of the hole-edge portion 70 and the main body 80, olefin resin, styrene resin, acryl resin, urethane resin, epoxy resin, silicon resin, amide resin, and carbonate resin may be given.

As examples of the rubber components of the hole-edge portion 70 and the main body 80, non-diene rubbers may be given. As the non-diene rubbers, butyl rubber (B), ethylene-propylene rubber (EPM), ethylene-propylene-diene rubber (EPDM), and urethane rubber (U) may be given. As a preferable example of the non-diene rubbers, ethylene-propylene-diene rubber (EPDM) may be given.

As another suitable example of the materials of the hole-edge portion 70 and the main body 80, a composite material TPV (Thermoplastic Vulcanizate) having a sea-island structure in which bridged rubber components are dispersed in a resin component may be given.

Additives of the hole-edge portion 70 and the main body 80 should not be particularly limited. For example, a filler, a plasticizer, a coloring agent, a stabilizer, a mold lubricant, a flame retarder, an aid, and other agents may be suitably added.

In a possible embodiment, both of the hole-edge portion material and the main body material should include at least one kind of resin selected from olefin resin, styrene resin, acryl resin, urethane resin, epoxy resin, silicon resin, amide resin, and carbonate resin. This improves affinity of the hole-edge portion 70 and the main body 80. This prevents the hole-edge portion 70 and the main body 80 from being separated from each other.

As a method of producing the dust cover 50 according to this embodiment, two-color molding of the hole-edge portion 70 and the main body 80 is preferable. In a non-limiting embodiment, the main body 80 is first molded in a mold, and then, the hole-edge portion 70 is molded in the same mold to produce the dust cover 50. Since the hard main body 80 is first molded, it is possible to prevent the portion first molded from being broken in the next molding.

### Effect of the Main Body 80 Including the Positioning Portion 60

An effect of the main body 80 including the positioning portion 60 will be described. Due to layout or other circumstances, a protruding length of the pinion shaft 204 from the housing 40 may be too short to secure a sufficient length of the recess 204e in the axial direction. In this case, force of securing the dust cover 50 to the pinion shaft 204 by fitting in the recess 204e is insufficient, and the pinion shaft 204 and the dust cover 50 rotate relative to each other. This may unfortunately cause unusual sound. In particular, in a low temperature state, when viscosity of the grease in the area 76 is increased, resisting force against rotation of the dust cover 50 is increased. Thus, rotation of the pinion shaft 204 and the dust cover 50 relative to each other is more likely to occur.

In view of this, in this embodiment, the main body 80 includes the positioning portion 60. The meshing portion 66 of the positioning portion 60 meshes with the serration grooves formed in the pinion shaft 204 in the axial direction. Consequently, the main body 80 including the positioning portion 60 prevents rotation of the pinion shaft 204 and the dust cover 50 relative to each other. This suppresses generation of the unusual sound.

Moreover, the main body 80 including the positioning portion 60 improves the assembling property of the dust cover 50.

### Embodiment 2

As described above, according to the embodiment, the dust cover 50 is made up of the two portions, namely, the main body 80 and the hole-edge portion 70 integral to each other, and the main body 80 is formed to be harder than the hole-edge portion 70. This configuration produces the effect of improving the sealing property and preventing the dust cover 50 from being turned over. The configuration should not be limited to the configuration illustrated in FIG. 4.

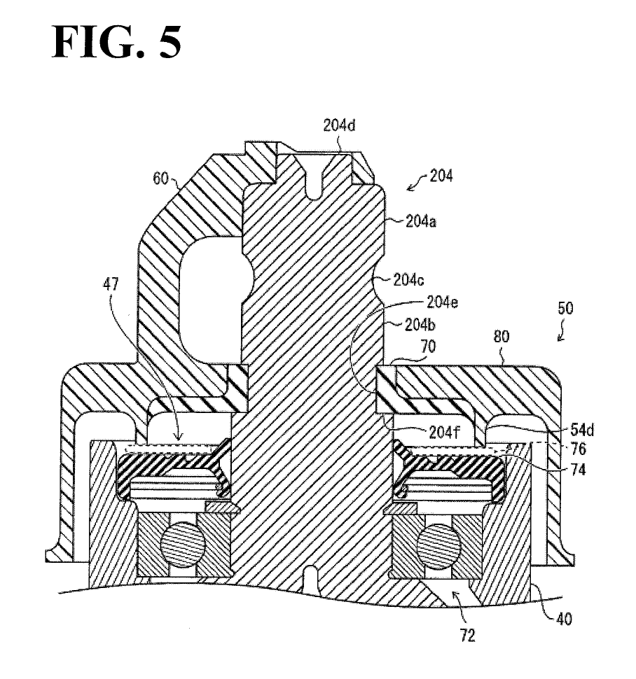

For example, FIG. 5 is a cross-sectional view of a dust cover according to embodiment 2. As illustrated in FIG. 5, on a rear surface side (housing side) of the dust cover 50, the hole-edge portion 70 may extend to an outer circumferential side of the dust cover 50. This increases a surface area of a portion where the hole-edge portion 70 and the main body 80 are joined so as to increase joining strength of the hole-edge portion 70 and the main body 80. In other words, an area of contact between the hole-edge portion 70 and the main body 80 is increased to further prevent the hole-edge portion 70 and the main body 80 from being separated from each other.

### Embodiment 3

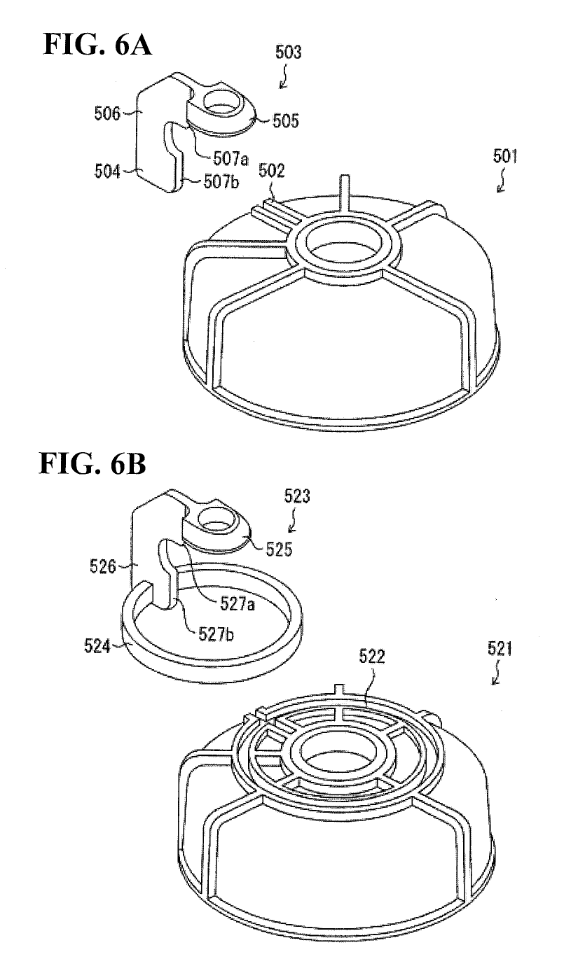

As described above, a positioning member separate from the dust cover may be provided. FIGS. 6A and 6B are perspective views of dust covers according to embodiment 3, illustrating exemplary configurations of the dust covers.

FIG. 6A is a perspective view of a dust cover 501 and a positioning member 503 according to this embodiment, illustrating schematic configurations of the dust cover 501 and the positioning member 503. The dust cover 501 does not include the positioning portion 60. Instead, the dust cover 501 includes a first fitting portion 502 to be fitted to the positioning member 503. Other than that, the configuration of the dust cover 501 is approximately the same as the configuration of the dust cover 50 according to embodiment 1. The positioning member 503 includes a second fitting portion 504, a crown portion 505, a protrusion 506, and meshing portions 507a and 507b. The second fitting portion 504 is fitted to the first fitting portion 502. The protrusion 506 protrudes outward in a radial direction of the pinion shaft. The meshing portions 507a and 507b mesh with serration grooves of the pinion shaft in the axial direction. The second fitting portion 504 is fitted to the first fitting portion 502 to secure the positioning member 503 to the dust cover 501. This configuration produces approximately the same effect as the dust cover 50 according to embodiment 1.

FIG. 6B is a perspective view of a dust cover 521 and a positioning member 523 according to this embodiment, illustrating schematic configurations of the dust cover 521 and the positioning member 523. The dust cover 521 does not include the positioning portion 60. Instead, the dust cover 521 includes a first fitting portion 522 to be fitted to the positioning member 523. Other than that, the configuration of the dust cover 521 is approximately the same as the configuration of the dust cover 50 according to embodiment 1. The positioning member 523 includes a second fitting portion 524, a crown portion 525, a protrusion 526, and meshing portions 527a and 527b. The second fitting portion 524 is fitted to the first fitting portion 522. The protrusion 526 protrudes outward in the radial direction of the pinion shaft. The meshing portions 527a and 527b mesh with serration grooves of the pinion shaft in the axial direction. The second fitting portion 524 is fitted to the first fitting portion 522 to secure the positioning member 523 to the dust cover 521. This configuration produces approximately the same effect as the dust cover 50 according to embodiment 1.

As illustrated in FIGS. 6A and 6B, when the positioning member 503 (523) and the dust cover 501 (521) are separate from each other, the positioning member 503 (523) may be made of harder material. When the positioning member 503 (523) is made of harder material, it is possible to improve workability in coupling the pinion shaft 204 to the second universal joint 202 (second joint yoke 26).

### Embodiment 4

In the above-described embodiments, the dust covers that cover the opening of the steering gearbox from which the input shaft protrudes have been described. The present invention, however, should not be limited to these embodiments. The present invention is also applicable to dust boots (dust covers) to cover openings of the steering gearbox from which a rack shaft and tie rods, for example, protrude.

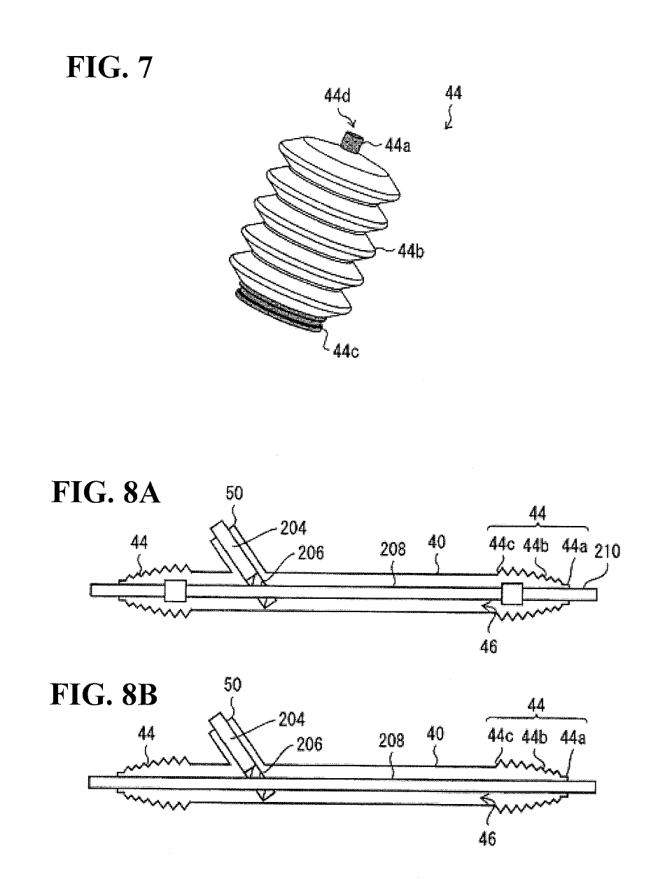

A dust boot according to embodiment 4 will now be described with reference to FIGS. 7, 8A, and 8B. In the following description, the dust boot according to embodiment 4 is incorporated in the steering device described in embodiment 1. The dust boot according to embodiment 4, however, may be incorporated in any desired steering device.

FIG. 7 is a perspective view of the dust boot (dust cover) 44 according to embodiment 4. FIGS. 8A and 8B are cross-sectional views of the dust boots 44 according to embodiment 4 and components surrounding it. As illustrated in FIGS. 8A and 8B, the dust boot 44 covers an opening 46 of the housing 40. FIG. 8A illustrates a configuration in which the tie rods (shafts, pipes) 210, which move integrally with the rack bar (shaft, pipe) 208, extend through the opening 46. FIG. 8B illustrates a configuration in which the rack bar 208 extends through the opening 46. Embodiment 4, however, should not be limited to these configurations. Embodiment 4 is applicable insofar as the rack bar 208 or any desired shaft or pipe, which moves integrally with the rack bar 208, extends through the opening 46. The rack bar 208 and the tie rods 210 may be shafts and pipes.

As illustrated in FIG. 7, the dust boot 44 has a through hole 44d. The dust boot 44 includes a hole-edge portion 44a, a main body 44b, and an attachment portion 44c. The hole-edge portion 44a is disposed on an edge of the through hole 44d. The main body 44b covers the opening 46. The attachment portion 44c is attached to the housing 40. In the configuration illustrated in FIG. 8A, it is the tie rod 210 that extends through the through hole 44d, and the hole-edge portion 44a is attached to the tie rod 210. In the configuration illustrated in FIG. 8B, it is the rack bar 208 that extends through the through hole 44d, and the hole-edge portion 44a is attached to the rack bar 208.

In this embodiment, the hole-edge portion 44a and the attachment portion 44c are set to be harder than the main body 44b. More specifically, Shore hardness of the hole-edge portion 44a and Shore hardness of the attachment portion 44c are set to be higher than Shore hardness of the main body 44b. Shore hardness of the hole-edge portion 44a, the main body 44b, and the attachment portion 44c may be in a range in which Shore A is equal to or higher than 10/15, and Shore D is equal to or less than 50/15, for example. More preferably, for example, Shore hardness of the hole-edge portion 44a and Shore hardness of the attachment portion 44c may be equal to or higher than Shore A 60/15, and Shore hardness of the main body 44b may be less than Shore A 60/15.

In this manner, in this embodiment, the hole-edge portion 44a and the attachment portion 44c are formed to be harder than the main body 44b. Thus, rigidity of the hole-edge portion 44a is utilized to facilitate attachment of the hole-edge portion 44a to the rack bar 208 and the tie rods 210, for example. Also, rigidity of the attachment portion 44c is utilized to facilitate attachment of the attachment portion 44c to the housing 40. Meanwhile, the main body 44b is made softer to suitably follow steering movement (displacements of the rack bar 208 and the tie rods 210, for example).

It is noted that materials of the hole-edge portion 44a, the main body 44b, and the attachment portion 44c should not be particularly limited. Approximately the same materials as the hole-edge portion material and the main body material in embodiment 1 may be used.

### Embodiment 5

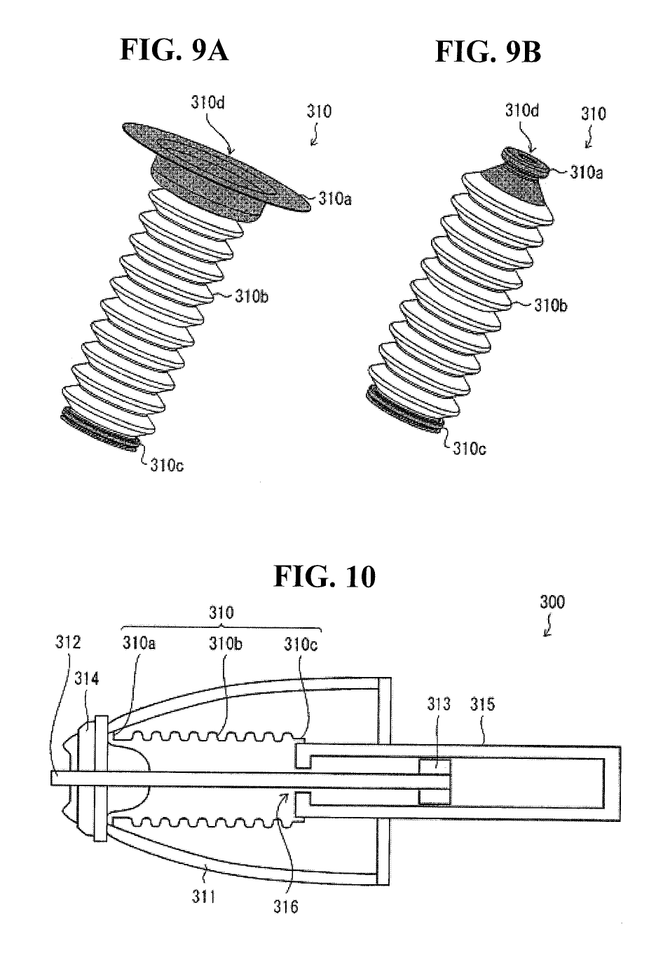

The present invention is also applicable to a dust cover to cover an opening of a damper from which a piston rod protrudes. A dust cover of a damper according to embodiment 5 will now be described with reference to FIGS. 9A, 9B, and 10.

FIGS. 9A and 9B are perspective views of dust covers 310 according to embodiment 5. FIGS. 9A and 9B illustrate variations of shapes of the dust covers 310. FIG. 10 is a cross-sectional view of a damper 300 according to embodiment 5. FIG. 10 illustrates a configuration in which the dust cover 310 of a shape illustrated in FIG. 9A is incorporated in the damper 300. Embodiment 5, however, should not be limited to this configuration.

In addition to the dust cover 310, the damper 300 includes a coil spring 311, a piston rod (shaft, pipe) 312, a piston valve 313, a coupling member 314, and a case (housing) 315. The piston rod 312 extends through an opening 316 formed in the outer shell 315. The dust cover 310 covers the opening 316. It is noted that the piston rod 312 may be a shaft and a pipe.

The dust cover 310 has a through hole 310d through which the piston rod 312 extends. The dust cover 310 includes a hole-edge portion 310a, a main body 310b, and an attachment portion 310c. The hole-edge portion 310a is disposed on an edge of the through hole 310d. The main body 310b covers the opening 316. The attachment portion 310c is attached to the case 315. The hole-edge portion 310a is attached to the piston rod 312 through the coupling member 314. It is noted that when the dust cover 310 has a shape illustrated in FIG. 9B, the hole-edge portion 310a may be directly attached to the piston rod 312.

In this embodiment, the hole-edge portion 310a and the attachment portion 310c are set to be harder than the main body 310b. More specifically, Shore hardness of the hole-edge portion 310a and Shore hardness of the attachment portion 310c are set to be higher than Shore hardness of the main body 310b. Shore hardness of the hole-edge portion 310a, the main body 310b, and the attachment portion 310c may be in a range in which Shore A is equal to or higher than 10/15, and Shore D is equal to or less than 50/15, for example. More preferably, for example, Shore hardness of the hole-edge portion 310a and Shore hardness of the attachment portion 310c may be equal to or higher than Shore A 60/15, and Shore hardness of the main body 310b may be less than Shore A 60/15.

In this manner, in this embodiment, the hole-edge portion 310a and the attachment portion 310c are formed to be harder than the main body 310b. Thus, rigidity of the hole-edge portion 310a is utilized to facilitate attachment of the hole-edge portion 310a to the coupling member 314 or the piston rod 312. Also, rigidity of the attachment portion 310c is utilized to facilitate attachment of the attachment portion 310c to the case 315. Meanwhile, the main body 310b is made softer to suitably follow suspension movement (displacement of the piston rod 312).

It is noted that materials of the hole-edge portion 310a, the main body 310b, and the attachment portion 310c should not be particularly limited. Approximately the same materials as the hole-edge portion material and the main body material in embodiment 1 may be used.

Concerning the dust covers disclosed in JP-2013-067280-A, JP-2012-066670-A and JP-2013-043555-A, it is still to be discussed how to make two different properties coexist; for example, a sealing property and a property of preventing the dust cover from being turned over, and a property of following movement and an assembling property.

The dust cover according to the embodiment is made up of a hole-edge portion and a main body that have different hardnesses. Thus, two different properties coexist.

The dust cover according to the embodiment makes the two different properties coexist, namely, the dust cover improved in both of the sealing property and the property of preventing the dust cover from being turned over, and both of the property of following movement and the assembling property. The steering device according to another embodiment and the damper according to still another embodiment each include the dust cover.

Obviously, numerous modifications and variations of the present invention are possible in light of the above teachings. Such modifications and variations will also fall within the scope of the invention.

1. A dust cover to cover an opening of a housing through which a shaft or pipe extends, the dust cover comprising:
a hole-edge portion defining an edge of a through hole through which the shaft or pipe is extendable; and
a main body configured to cover the opening, the main body comprising a hardness different from a hardness of the hole-edge portion.

2. The dust cover according to claim 1,
wherein a hole-edge portion material of the hole-edge portion and a main body material of the main body each comprise a resin component and a rubber component,
such that a compounding ratio of a resin component and a rubber component of the hole-edge portion material is different from a compounding ratio of a resin component and a rubber component of the main body material, or
such that one of the hole-edge portion material and the main body material comprises a resin component and a rubber component, and another of the hole-edge portion material and the main body material comprises a resin component and no rubber component.

3. The dust cover according to claim 2,
wherein both of the hole-edge portion material and the main body material comprise at least one kind of resin selected from
olefin resin,
styrene resin,
acryl resin,
urethane resin,
epoxy resin,
silicon resin,
amide resin, and
carbonate resin.

4. The dust cover according to claim 1,
wherein the hole-edge portion is greater in hardness than the main body.

5. The dust cover according to claim 1,
wherein the main body is greater in hardness than the hole-edge portion.

6. The dust cover according to claim 1,
wherein the housing comprises a steering gearbox, and
wherein the at least one of the shaft and the pipe comprises an input shaft.

7. The dust cover according to claim 6,
wherein the main body comprises a positioning portion configured to determine a position of a universal joint coupled to the input shaft, the positioning portion comprising:
a meshing portion configured to mesh with serration grooves disposed in the input shaft in an axial direction of the input shaft; and
a protrusion protruding outward in a radial direction of the input shaft.

8. The dust cover according to claim 1,
wherein the housing comprises a steering gearbox, and
wherein the at least one of the shaft and the pipe comprises at least one of a rack shaft, a shaft, and a pipe, the shaft and the pipe being movable integrally with the rack shaft.

9. The dust cover according to claim 1,
wherein the housing comprises a damper case, and
wherein the at least one of the shaft and the pipe comprises a piston rod.

10. A steering device comprising:
a housing;
at least one of a shaft and a pipe extending through an opening disposed in the housing; and
a dust cover configured to cover the opening, the dust cover comprising:
a hole-edge portion defining an edge of a through hole through which the at least one of the shaft and the pipe is extendable; and
a main body configured to cover the opening, the main body comprising a hardness different from a hardness of the hole-edge portion.

11. A damper comprising:
a case;
a piston rod extending through an opening formed in the case; and
a dust cover configured to cover the opening, the dust cover comprising:
a hole-edge portion defining an edge of a through hole through which the piston rod is extendable; and
a main body configured to cover the opening, the main body comprising a hardness different from a hardness of the hole-edge portion.

12. The dust cover according to claim 2,
wherein the hole-edge portion is greater in hardness than the main body.

13. The dust cover according to claim 3,
wherein the hole-edge portion is greater in hardness than the main body.

14. The dust cover according to claim 2,
wherein the main body is greater in hardness than the hole-edge portion.

15. The dust cover according to claim 3,
wherein the main body is greater in hardness than the hole-edge portion.

16. The dust cover according to claim 2,
wherein the housing comprises a steering gearbox, and
wherein the at least one of the shaft and the pipe comprises an input shaft.

17. The dust cover according to claim 3,
wherein the housing comprises a steering gearbox, and
wherein the at least one of the shaft and the pipe comprises an input shaft.

18. The dust cover according to claim 4,
wherein the housing comprises a steering gearbox, and
wherein the at least one of the shaft and the pipe comprises an input shaft.

19. The dust cover according to claim 5,
wherein the housing comprises a steering gearbox, and
wherein the at least one of the shaft and the pipe comprises an input shaft.

20. The dust cover according to claim 12,
wherein the housing comprises a steering gearbox, and
wherein the at least one of the shaft and the pipe comprises an input shaft.
